(19) United States
(12) Patent Application Publication
(10) Pub. No.: US 2023/0337739 A1
(43) Pub. Date: Oct. 26, 2023

(54) AEROSOL PROVISION SYSTEM

(71) Applicant: Nicoventures Trading Limited, London (GB)

(72) Inventor: Patrick Moloney, London (GB)

(21) Appl. No.: 17/780,109

(22) PCT Filed: Nov. 27, 2020
(86) PCT No.: PCT/EP2020/083790

§ 371 Date: May 26, 2022

(30) Foreign Application Priority Data
Nov. 29, 2019 (GB) 1917444.0

(51) Int. Cl. A24F 40/46; A24F 40/10; A24F 40/57; A24F 40/51

(52) U.S. Cl. CPC A24F 40/46; A24F 40/10; A24F 40/57; A24F 40/51

(57) ABSTRACT

An aerosol provision system including an energy store, wherein the discharge current of the energy store is less than 2 C or less than 0.5 C.

### RELATED APPLICATION INFORMATION

The present application is a National Phase entry of PCT Application No. PCT/EP2020/083790, filed Nov. 27, 2020, which claims priority from GB Patent Application No. 1917444.0, filed Nov. 29, 2019, each of which is hereby fully incorporated herein by reference.

### TECHNICAL FIELD

The present invention relates to an aerosol provision system, a method of producing an aerosol from an aerosol provision system, aerosol provision means and an electronic aerosol provision system.

### BACKGROUND

Aerosol provision systems are known. Aerosol provision systems often have energy stores which, in use, provide energy to enable an aerosol generating medium to be aerosolised prior to inhalation by a user. Modern devices operate on demand as a result of a user pushing a button or inhaling on the device prior to a puff being delivered to the user. Such devices rapidly deliver energy from the energy store to an aerosol generating mechanism in the device to reduce the time between the user indication of a desire for a puff and the delivery of the puff.

It is desirable to reduce the time between the indication of a desire for a puff and the delivery of the puff.

The present invention is directed toward solving some of the above problems.

### SUMMARY

Aspects of the invention are defined in the accompanying claims.

In accordance with a first aspect described herein, there is provided an aerosol provision system comprising an energy store, wherein the discharge current of the energy store is less than 2 C or less than 0.5 C.

In an embodiment, there is provided an aerosol generating mechanism for providing aerosol from an aerosol generating medium, wherein the energy store is arranged to directly deliver energy to the heater for heating.

In an embodiment, the aerosol generating mechanism is a heater.

In an embodiment, the heater has a high thermal mass.

In an embodiment, the heater has a mass of around 5 grams.

In an embodiment, the aerosol provision system has a power section comprising the energy store and a heater section comprising the heater, wherein the power section and heater section are removably connectable to one another.

In an embodiment, the energy store provides energy to the heater to reach an operational temperature for a first smoking session, wherein the operational temperature is a temperature sufficient to generate an aerosol from an aerosol generating medium, the heater having a rate of heat transfer so that, in use, at least some energy provided to the heater for the first smoking session is retained to generate an aerosol from an aerosol generating medium in a second smoking session, wherein the second smoking session is subsequent to the first smoking session.

In an embodiment, the operational temperature is from around 220° C. to around 260° C.

In an embodiment, the rate of heat transfer of the heater is from around 15 J/s to around J/s.

In an embodiment, the second smoking session is around 5 seconds to 20 seconds subsequent to the first smoking session.

In accordance with a second aspect described herein, there is provided a method of producing an aerosol from an aerosol provision system, the method comprising providing energy to a heater to produce an aerosol from an aerosol generating medium, providing an aerosol from an aerosol generating medium for a first smoking session, cease providing energy to the heater, providing an aerosol from an aerosol generating medium for a second smoking session, wherein the second smoking session occurs at least 30 s after the step of cease providing energy the heater.

In an embodiment, the rate of provision of energy to the heater to produce an aerosol is around 15 to 30 J/s.

In accordance with a third aspect described herein, there is provided an aerosol provision system including a heater for generating an aerosol from an aerosol precursor, the heater having a thermal capacity TC and the aerosol generation taking a power level of PL, wherein the ratio TC/PL exceeds a predetermined threshold PT.

In an embodiment, there is provided an energy store, wherein the discharge current of the energy store is less than 2 C or less than 0.5 C.

In an embodiment, the aerosol provision system has a power section comprising the energy store and a heater section comprising the heater, wherein the power section and heater section are removably connectable to one another.

In an embodiment, the heater has a mass of around 5 grams.

In an embodiment, the heater has an operational temperature of from around 220° C. to around 260° C.

In an embodiment, the heater has a rate of heat transfer from around 15 J/s to around 30 J/s.

In accordance with some embodiments a fourth aspect described herein, there is provided an aerosol provision system or an aerosol provision means, wherein the discharge current of the energy store means is less than 2 C or less than 0.5 C.

According to another aspect there is provided an aerosol provision system comprising:
an energy store;
a heater for generating an aerosol from an aerosol generating medium, wherein the heater has a first specific heat capacity x J/(kg·K); and
a control mechanism, wherein the control mechanism is arranged and adapted:
(i) to cause energy to be transferred from the energy store to the heater, wherein the energy transferred to the heater is sufficient for the heater to reach an operational temperature or operational status which is sufficient to produce an aerosol from an aerosol generating medium during the course of one or more smoking sessions;
(ii) to cause an aerosol to be provided from the aerosol generating medium during a first smoking session;
(iii) to cause the energy store to cease transferring energy to the heater; and
(iv) to cause an aerosol to be provided from the aerosol generating medium during a second and optionally further subsequent smoking session(s).

The heater may have a mass in the range: (i) <2 g; (ii) 2-3 g; (iii) 3-4 g; (iv) 4-5 g; (v) 5-6 g; (vi) 6-7 g; (vii) 7-8 g; (viii) 8-9 g; (ix) 9-10 g; or (x) >10 g.

The thermal mass of the heater may be in the range: (i) <1 J/degree-C; (ii) 1-2 J/degree-C; (iii) 2-3 J/degree-C; or (iv) >3 J/degree-C.

According to an embodiment x is in the range: (i) 400-500; (ii) 500-600; (iii) 600-700; (iv) 700-800; (v) 800-900; (vi) 900-1000; or (vi) >1000.

According to an embodiment the discharge current of the energy store is less than 2 C or less than 0.5 C.

According to another aspect there is provided a method producing an aerosol comprising:
providing an energy store;
providing a heater for generating an aerosol from an aerosol generating medium, wherein the heater has a first specific heat capacity x J/(kg·K);
causing energy to be transferred from the energy store to the heater, wherein the energy transferred to the heater is sufficient for the heater to reach an operational temperature or operational status which is sufficient to produce an aerosol from an aerosol generating medium during the course of one or more smoking sessions;
causing an aerosol to be provided from the aerosol generating medium during a first smoking session;
causing the energy store to cease transferring energy to the heater; and
causing an aerosol to be provided from the aerosol generating medium during a second and optionally further subsequent smoking session(s).

The heater may have a mass in the range: (i) <2 g; (ii) 2-3 g; (iii) 3-4 g; (iv) 4-5 g; (v) 5-6 g; (vi) 6-7 g; (vii) 7-8 g; (viii) 8-9 g; (ix) 9-10 g; or (x) >10 g.

The thermal mass of the heater may be in the range: (i) <1 J/degree-C; (ii) 1-2 J/degree-C; (iii) 2-3 J/degree-C; or (iv) >3 J/degree-C.

According to an embodiment x is in the range: (i) 400-500; (ii) 500-600; (iii) 600-700; (iv) 700-800; (v) 800-900; (vi) 900-1000; or (vi) >1000.

According to another aspect there is provided an aerosol provision system comprising:
an energy store;
a heater for generating an aerosol from an aerosol generating medium, wherein the heater has a first specific heat capacity x J/(kg·K); and
a control mechanism.

The control mechanism may be arranged and adapted to cause energy to be transferred from the energy store to the heater, wherein the energy transferred to the heater is sufficient for the heater to reach an operational temperature or operational status which is sufficient to produce an aerosol from an aerosol generating medium during the course of one or more smoking sessions.

The control mechanism may be arranged and adapted to cause an aerosol to be provided from the aerosol generating medium during a first smoking session.

The control mechanism may be arranged and adapted to cause the energy store to cease transferring energy to the heater.

The control mechanism may be arranged and adapted to cause an aerosol to be provided from the aerosol generating medium during a second and optionally further subsequent smoking session(s).

According to another aspect there is provided a method producing an aerosol comprising:
providing an energy store;
providing a heater for generating an aerosol from an aerosol generating medium, wherein the heater has a first specific heat capacity x J/(kg·K); and
causing energy to be transferred from the energy store to the heater.

The energy transferred to the heater may be sufficient for the heater to reach an operational temperature or operational status which is sufficient to produce an aerosol from an aerosol generating medium during the course of one or more smoking sessions.

The method may further comprise causing an aerosol to be provided from the aerosol generating medium during a first smoking session.

The method may further comprise causing the energy store to cease transferring energy to the heater.

The method may further comprise causing an aerosol to be provided from the aerosol generating medium during a second and optionally further subsequent smoking session(s).

### DESCRIPTION OF DRAWINGS

The present teachings will now be described by way of example only with reference to the following figure:

FIG. 1 is a longitudinal cross-sectional view of an aerosol provision system according to an example;

FIG. 2 is a longitudinal cross-sectional view of an aerosol provision system according to an example;

FIG. 3 is a longitudinal cross-sectional view of an aerosol provision system according to an example; and,

FIG. 4 is a schematic flowchart for a method of producing an aerosol according to an example.

While the invention is susceptible to various modifications and alternative forms, specific embodiments are shown by way of example in the drawings and are herein described in detail. It should be understood, however, that the drawings and detailed description of the specific embodiments are not intended to limit the invention to the particular forms disclosed. On the contrary, the invention covers all modifications, equivalents and alternatives falling within the scope of the present invention as defined by the appended claims.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

The present disclosure relates to aerosol provision systems, which may also be referred to as aerosol provision systems, such as e-cigarettes. According to the present disclosure, a “non-combustible” aerosol provision system is one where a constituent aerosolizable material of the aerosol provision system (or component thereof) is not combusted or burned in order to facilitate delivery to a user. Throughout the following description the term “e-cigarette” or “electronic cigarette” may sometimes be used, but it will be appreciated this term may be used interchangeably with aerosol provision system/device and electronic aerosol provision system/device. Furthermore, and as is common in the technical field, the terms “aerosol” and “vapour”, and related terms such as “vaporise”, “volatilise” and “aerosolise”, may generally be used interchangeably.

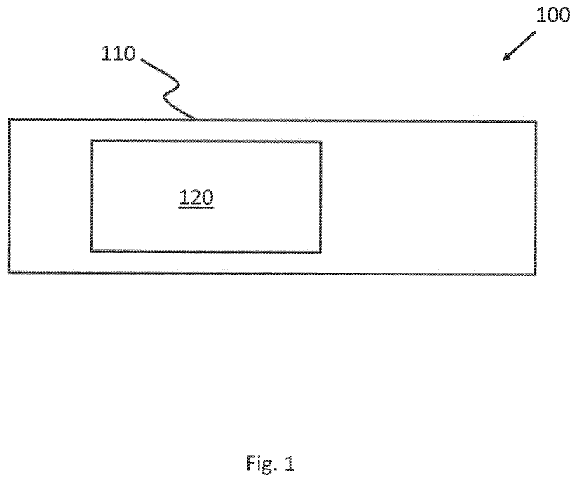

In the example of FIG. 1, an aerosol provision system 100 is shown. The aerosol provision system 100 comprises energy store 120. The energy store 120 has a discharge current of less than 2 C. In embodiments the energy store 120 may have a discharge current of less than 1 C. According to an embodiment the energy store 120 may have a discharge current of less than 0.5 C. In other examples, the energy store 120 may have a discharge current of less than 0.4 C, less than 0.3 C, less than 0.2 C or less than 0.1 C.

It is contemplated that the energy store 120 may have a discharge current in the range <0.1 C, 0.1-0.2 C, 0.2-0.3 C, 0.3-0.4 C, 0.4-0.5 C, 0.5-0.6 C, 0.6-0.7 C, 0.7-0.8 C, 0.8-0.9 C, 0.9-1.0 C, 1.0-1.1 C, 1.1-1.2 C, 1.2-1.3 C, 1.3-1.4 C, 1.4-1.5 C, 1.5-1.6 C, 1.6-1.7 C, 1.7-1.8 C, 1.8-1.9 C or 1.9-2.0 C.

A 1 C discharge rate would mean that the discharge current will discharge the entire energy store in 1 hour. For an energy store with a capacity of, for example, 100 Amp-hours, this would equate to a discharge current of 100 Amps. A 5 C rate for such an energy store would be 500 Amps, and a C/2 rate would be 50 Amps.

The ability to discharge at a lower current can unlock greater battery capacity (mAh) in the same form factor with same chemistry or differing chemistries. This may deliver a better battery efficiency factor.

The energy store 120 may, in an example, be a battery. The energy store 120 may contain chemical energy which can be converted and delivered as electrical energy. Energy stores in modern systems attempt to rapidly deliver energy from the energy store to an aerosol generating mechanism which can place high levels of stress on electronics in the aerosol provision system. The energy store 120 of an embodiment of the presently disclosed aerosol provision system 100 instead has a discharge current of less than 0.5 C. This may reduce the stress on electronics in the aerosol provision system 100.

An energy store 120 as described above has a lower performance requirement than those required to rapidly deliver energy. As such, the energy store 120 may be a lower cost energy store and therefore reduces the cost of the aerosol provision system 100.

In example shown in FIG. 1, the aerosol provision system 100 has a housing 110 within which the energy store 120 is located.

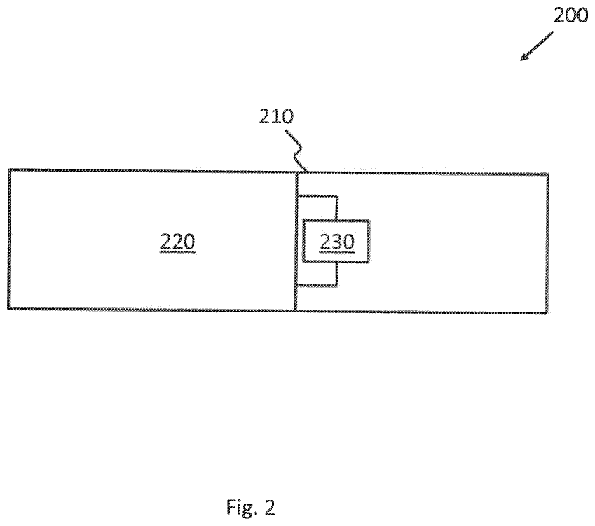

In the example of FIG. 2, an aerosol provision system 200 is shown. The aerosol provision system 200 comprises an energy store 220. The aerosol provision system 200 comprises a aerosol generating mechanism 230. The aerosol generating mechanism 230 is for providing aerosol from an aerosol generating medium. In an example the aerosol generating mechanism 230 may be a heater 230. The heater 230 may be for providing heat to an aerosol generating medium. The heater 230 may be a resistive heater 230. The energy store 220 may be arranged to directly deliver energy to the heater 230 for heating. The heater 230 may be an induction heater, or part of an induction heating system. In the example wherein the heater 230 is an induction heater or part of an induction heating system the system may have higher peak currents than in a resistive heating system.

The heater 230 may comprise one or more electrically resistive heaters, including for example one or more nichrome resistive heater(s) and/or one or more ceramic heater(s). The one or more heaters may comprise one or more induction heaters which includes an arrangement comprising one or more susceptors which may form a chamber into which an article comprising aerosolizable material is inserted or otherwise located in use. Alternatively or in addition, one or more susceptors may be provided in the aerosolizable material. Other heating arrangements may also be used.

The heater 230 may have relatively low performance requirements as the heater 230 is not provided with energy from the energy store 220 to be heated rapidly. As such, this can reduce the cost of the heater 230 and therefore the cost of the aerosol provision system 200. The heater 230 may be operated at around 3 W or so.

The cost of the heater 230 or the overall cost of the overall aerosol provision system 200 may be reduced. The heater 230 may be a e.g. Positive Temperature Coefficient (“PTC”) type which would self-regulate the temperature which could negate some of the software controls currently used. Reducing the power draw or peak currents could provide a greater range of options in relation to battery types and chemistries etc., also which would reduce overall aerosol provision system 200 costs.

The heater 230 may have a high thermal mass. In this regard, the heater 230 may be provided with energy from the energy store 220 for providing an aerosol. The heater 230 may retain the energy as heat energy over an extended period of time as a result of the high thermal mass. The high thermal mass hinders the heater 230 from heating up quickly. The high thermal mass assists the heater 230 to remain hot after reaching a suitable temperature to produce an aerosol from an aerosol generating medium.

High thermal mass may be taken to mean, herein, that the heater 230 is capable of storing around 50 J or more of energy. In an example, the energy store 220 may supply around 3 J/s. Aerosolization may occur of aerosol generating material around 60 J and a puff may have a duration of around 3 seconds. The mass of the heater 230 may provide energy sufficient to affect a temperature range of between around 220° C. to around 280° C.

As will be understood by those skilled in the art, the term or concept of thermal mass may be defined as the energy stored per unit change in temperature, and can be calculated for a uniform piece of material by multiplying the mass by its specific heat capacity. Accordingly, if the heater 230 has a mass of 5 grams and is made from steel then its thermal mass would be around 2 J/degree-C.

The energy may be stored in a phase-change material (PCM). The energy may be held at a more constant temperature. The PCM may be provided with a transition temperature around the desired typical operational temperatures (e.g. these may be 220 to 280° C., or other suitable ranges). The PCM may additionally limit the maximum temperature provided to aerosol generating material. This in turn may reduce negative impact of high temperatures on taste and toxicity profiles.

The high thermal mass heater 230 may therefore reduce the time between a user indication of desire for a puff and the puff being delivered. The puff can be delivered immediately on request of a puff as the heater 230 is already at an operational temperature. Similarly, the high thermal mass heater 230 may remove the need for a user to signal intention to puff, via e.g. a button on the housing 210 of the aerosol provision system 200. Instead, the user may inhale on the system 200 and be provided with aerosol immediately.

The heater 230 may be made of a thermally conductive material, such as metal or ceramic. In a particular example, the heater 230 is made of alumina. The heater 230 may have a mass of around 5 grams. In a specific example wherein the heater 230 is made of steel, the heater 230 may have a mass of around 5 grams or so. The dimensions may be around less than 700 mm³ or so. The shape of the heater 230 may be chosen to reduce heat losses from external surfaces.

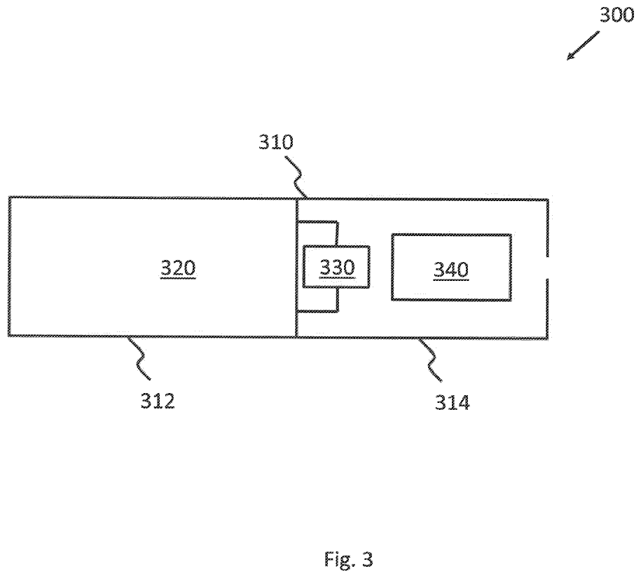

In the example of FIG. 3, an aerosol provision system 300 is shown. The aerosol provision system 300 shown in FIG. 3 has an aerosol generating medium 340 located within the housing 310 of the aerosol provision system 300. The housing 310 of the aerosol provision system 300 may have a plurality of parts.

In the example shown in FIG. 3, the system 300 has a power section 312 and a heater section 314. The power section 312 comprises the energy store 320. The heater section 314 comprises the heater 330. In the example of FIG. 3, the heater section 314 has an aerosol generating medium 340 located within it. The power section 312 and the heater section 314 may be arranged to be removably connectable to one another. In this way the aerosol provision system 300 may be modular. The power section 312 and the heater section 314 may connect via a push fit connection, or a screw fit connection or the like.

The heater 330 and the energy store 320 may be connected by circuitry or the like. This circuitry may become a complete circuit upon connection of the power section 312 and the heater section 314. Energy may be provided to the heater 330 from the energy store 320 via the circuitry.

The heater 330 and aerosol generating medium 340 may be arranged as shown, or may be arranged in a heater-and-wick combination. The aerosol generating medium 340 may therefore be a liquid which is delivered to the wick and then aerosolised by the heat from the heater 330. The aerosol generating medium 340 may be contained in a liquid reservoir or the like. The aerosol generating mechanism 330 may be part of a cartomizer or the like.

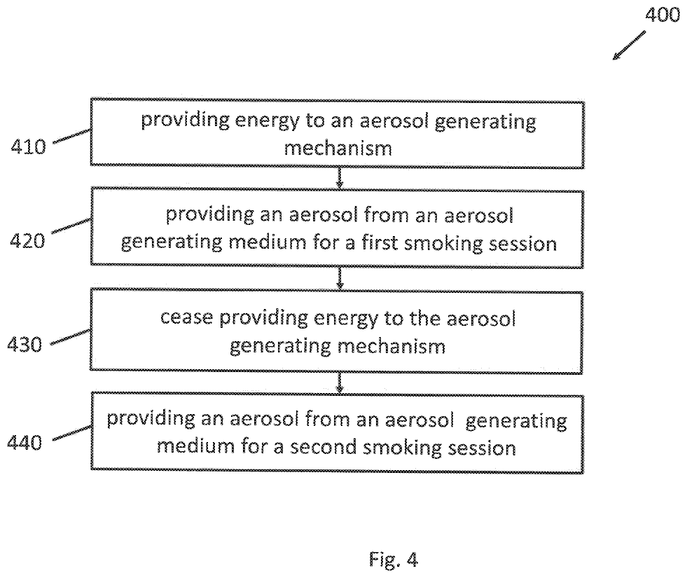

In FIG. 4 a schematic flowchart for a method of producing an aerosol is shown. The method 400 is shown with four steps 410, 420, 430, 440. The first step 410 involves providing energy to an aerosol generating mechanism. The aerosol generating mechanism may be in the form of a heater. Energy may be provided to the aerosol generating mechanism from an energy store. The energy store may be a battery or the like. The energy provided to the aerosol generating mechanism may be sufficient for the mechanism to reach an operational condition, such as an operational temperature, to produce an aerosol from an aerosol generating medium.

The second step 420 involves providing an aerosol from an aerosol generating medium for a first smoking session. The energy provided to the aerosol generating mechanism may be conveyed to an aerosol generating medium such that an aerosol is produced. This aerosol may be inhaled by a user during a first smoking session. A first smoking session may last for a number of puffs, e.g. 8 to 12 puffs. The aerosol produced during this second step 420 may be arranged to provide for up to or at least 12 puffs. In an example, at least one puff should be provided during this step 420. The rate of provision of energy to the heater to produce an aerosol may be around 15 J/s or so. The rate may vary based on the aerosol generating material which may be an e-liquid or tobacco or the like. For a gel system, the provision of energy to the heater to produce an aerosol may be around 30 J/s or so. Aerosol generating material with high water content, for example, may require greater rates of provision of energy due to the high thermal mass of water.

The third step 430 involves ceasing provision of energy to the aerosol generating mechanism. This may be as a result of the cessation of a smoking session as detected by e.g. a puff sensor or the like. Alternatively, once a specific amount of energy is delivered to the aerosol generating mechanism, the energy store may cease providing energy to the aerosol generating mechanism. The specific amount of energy delivered may be detected by a drop in energy in the energy store or by the detection of a property of the aerosol generating mechanism. This may, in the example wherein the aerosol generating mechanism is a heater, be via detection of the heater reaching a specific operational temperature. The operational temperature may be from around 220° C. to around 260° C. Such a temperature enables an aerosol to be produced from media such as tobacco, nicotine, acid, glycerol, etc. Other temperatures may be used for other media requiring, or preferentially producing aerosols at, different temperature ranges.

The fourth step 440 involves providing an aerosol from an aerosol generating medium for a second smoking session. The aerosol generating mechanism retains the energy provided by the energy store so that aerosol can be provided from an aerosol generating medium during a second smoking session. The second smoking session is after the first smoking session and occurs after the cessation of provision of energy to the aerosol generating mechanism. The second smoking session may occur up to 5 seconds after the first smoking session, up to 10 seconds after the first smoking session, up to 15 seconds after the first smoking session, up to seconds after the first smoking session, up to 25 seconds after the first smoking session, up to 30 seconds after the first smoking session, up to 35 seconds after the first smoking session, up to 50 seconds after the first smoking session, up to 45 seconds after the first smoking session etc.

The aerosol generating mechanism may be a heater which has a rate of heat transfer so that energy provided to the heater for the first smoking session is retained to generate an aerosol from an aerosol generating medium in a second smoking session. The heater may have a thermal heat capacity or a thermal conductivity based on the factors as described above. The material used in the heater may vary and therefore conductivity may vary from around 5 to 400 W/m/K.

The present system allows a greater freedom in relation to the use of low specification energy stores. For example, as the energy delivery from the energy store is at a low rate a lower specification energy store than is used in common systems may be used. This can reduce the overall cost of the system disclosed herein.

The aerosol provision system disclosed herein may be user activated, in the manner of a push button on the housing of the system or the like. This may provide a signal to the device is, and is not, in use and therefore when to deliver energy to the aerosol generating mechanism. In other embodiments, there is no need for a push button and a puff detector may be used.

In some embodiments, the non-combustible aerosol provision system is an electronic cigarette, also known as a vaping device or electronic nicotine delivery system (END), although it is noted that the presence of nicotine in the aerosolizable material is not a requirement.

In some embodiments, the aerosolizable material comprises one or more polyhydric alcohols, such as propylene glycol, triethylene glycol, 1,3-butanediol and glycerin; esters of polyhydric alcohols, such as glycerol mono-, di- or triacetate; and/or aliphatic esters of mono-, di- or polycarboxylic acids, such as dimethyl dodecanedioate and dimethyl tetradecanedioate.

In some embodiments, the aerosolizable material may be in the form of a gel. In some embodiments, the gel may comprise a gelling agent. The gelling agent may comprise one or more compounds selected from cellulosic gelling agents, non-cellulosic gelling agents, guar gum, acacia gum and mixtures thereof.

In some embodiments, the cellulosic gelling agent is selected from the group consisting of: hydroxymethyl cellulose, hydroxyethyl cellulose, hydroxypropyl cellulose, carboxymethylcellulose (CMC), hydroxypropyl methylcellulose (HPMC), methyl cellulose, ethyl cellulose, cellulose acetate (CA), cellulose acetate butyrate (CAB), cellulose acetate propionate (CAP) and combinations thereof.

In some embodiments, the gelling agent comprises (or is) one or more of hydroxyethyl cellulose, hydroxypropyl cellulose, hydroxypropyl methylcellulose (HPMC), carboxymethylcellulose, guar gum, or acacia gum.

In some embodiments, the gelling agent comprises (or is) one or more non-cellulosic gelling agents, including, but not limited to, agar, xanthan gum, gum Arabic, guar gum, locust bean gum, pectin, carrageenan, starch, alginate, and combinations thereof. In preferred embodiments, the non-cellulose based gelling agent is alginate or agar.

The aerosolizable material may comprise an acid. The acid may be an organic acid. In some of these embodiments, the acid may be at least one of a monoprotic acid, a diprotic acid and a triprotic acid. In some such embodiments, the acid may contain at least one carboxyl functional group. In some such embodiments, the acid may be at least one of an alpha-hydroxy acid, carboxylic acid, dicarboxylic acid, tricarboxylic acid and keto acid. In some such embodiments, the acid may be an alpha-keto acid.

In some such embodiments, the acid may be at least one of succinic acid, lactic acid, benzoic acid, citric acid, tartaric acid, fumaric acid, levulinic acid, acetic acid, malic acid, formic acid, sorbic acid, benzoic acid, propanoic and pyruvic acid.

Suitably the acid is lactic acid. In other embodiments, the acid is benzoic acid. In other embodiments the acid may be an inorganic acid. In some of these embodiments the acid may be a mineral acid. In some such embodiments, the acid may be at least one of sulphuric acid, hydrochloric acid, boric acid and phosphoric acid. In some embodiments, the acid is levulinic acid.

In certain embodiments, the aerosolizable material comprises a gelling agent comprising a cellulosic gelling agent and/or a non-cellulosic gelling agent, an active substance and an acid.

In some embodiments, the aerosolizable material comprises one or more cannabinoid compounds selected from the group consisting of: cannabidiol (CBD), tetrahydrocannabinol (THC), tetrahydrocannabinolic acid (THCA), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM) and cannabielsoin (CBE), cannabicitran (CBT).

The aerosolizable material may comprise one or more cannabinoid compounds selected from the group consisting of cannabidiol (CBD) and THC (tetrahydrocannabinol).

The aerosolizable material may comprise cannabidiol (CBD).

The aerosolizable material may comprise nicotine and cannabidiol (CBD).

The aerosolizable material may comprise nicotine, cannabidiol (CBD), and THC (tetrahydrocannabinol).

In some embodiments, the non-combustible aerosol provision system is a tobacco heating system, also known as a heat-not-burn system.

In some embodiments, the non-combustible aerosol provision system is a hybrid system to generate aerosol using a combination of aerosolizable materials, one or a plurality of which may be heated. Each of the aerosolizable materials may be, for example, in the form of a solid, liquid or gel and may or may not contain nicotine. In some embodiments, the hybrid system comprises a liquid or gel aerosolizable material and a solid aerosolizable material. The solid aerosolizable material may comprise, for example, tobacco or a non-tobacco product.

Typically, the non-combustible aerosol provision system may comprise a non-combustible aerosol provision device and an article for use with the non-combustible aerosol provision device. However, it is envisaged that articles which themselves comprise a means for powering an aerosol generating component may themselves form the non-combustible aerosol provision system.

In some embodiments, the article for use with the non-combustible aerosol provision device may comprise an aerosolizable material, an aerosol generating component, an aerosol generating area, a mouthpiece, and/or an area for receiving aerosolizable material.

In some embodiments, the aerosol generating component is a heater capable of interacting with the aerosolizable material so as to release one or more volatiles from the aerosolizable material to form an aerosol.

In some embodiments, the substance to be delivered may be an aerosolizable material. Aerosolizable material, which also may be referred to herein as aerosol generating material, is material that is capable of generating aerosol, for example when heated, irradiated or energized in any other way. Aerosolizable material may, for example, be in the form of a solid, liquid or gel which may or may not contain nicotine and/or flavorants. In some embodiments, the aerosolizable material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosolizable material may for example comprise from about 50 wt %, 60 wt % or 70 wt % of amorphous solid, to about 90 wt %, 95 wt % or 100 wt % of amorphous solid.

The amorphous solid may comprise a colorant. The addition of a colorant may alter the visual appearance of the amorphous solid. The presence of colorant in the amorphous solid may enhance the visual appearance of the amorphous solid and the aerosol-generating material. By adding a colorant to the amorphous solid, the amorphous solid may be color-matched to other components of the aerosol-generating material or to other components of an article comprising the amorphous solid.

A variety of colorants may be used depending on the desired color of the amorphous solid. The color of amorphous solid may be, for example, white, green, red, purple, blue, brown or black. Other colors are also envisaged. Natural or synthetic colorants, such as natural or synthetic dyes, food-grade colorants and pharmaceutical-grade colorants may be used. In certain embodiments, the colorant is caramel, which may confer the amorphous solid with a brown appearance. In such embodiments, the color of the amorphous solid may be similar to the color of other components (such as tobacco material) in an aerosol-generating material comprising the amorphous solid. In some embodiments, the addition of a colorant to the amorphous solid renders it visually indistinguishable from other components in the aerosol-generating material.

The colorant may be incorporated during the formation of the amorphous solid (e.g. when forming a slurry comprising the materials that form the amorphous solid) or it may be applied to the amorphous solid after its formation (e.g. by spraying it onto the amorphous solid).

The aerosolizable material may comprise one or more active constituents, one or more carrier constituents and optionally one or more other functional constituents.

In certain embodiments the aerosol-generating material or amorphous solid may comprise a gelling agent.

The active constituent may comprise one or more physiologically and/or olfactory active constituents which are included in the aerosolizable material in order to achieve a physiological and/or olfactory response in the user. The active constituent may for example be selected from nutraceuticals, nootropics, and psychoactives. The active constituent may be naturally occurring or synthetically obtained. The active constituent may comprise for example nicotine, caffeine, taurine, or any other suitable constituent. The active constituent may comprise a constituent, derivative or extract of tobacco or of another botanical. In some embodiments, the active constituent is a physiologically active constituent and may be selected from nicotine, nicotine salts (e.g. nicotine ditartrate/nicotine bitartrate), nicotine-free tobacco substitutes, other alkaloids such as caffeine.

In some embodiments, the active constituent is an olfactory active constituent and may be selected from a “flavor” and/or “flavorant” which, where local regulations permit, may be used to create a desired taste, aroma or other somatosensorial sensation in a product for adult consumers. In some instances such constituents may be referred to as flavors, flavorants, cooling agents, heating agents, or sweetening agents. They may include naturally occurring flavor materials, botanicals, extracts of botanicals, synthetically obtained materials, or combinations thereof (e.g., tobacco, cannabis, licorice (liquorice), hydrangea, eugenol, Japanese white bark magnolia leaf, chamomile, fenugreek, clove, maple, matcha, menthol, Japanese mint, aniseed (anise), cinnamon, turmeric, Indian spices, Asian spices, herb, wintergreen, cherry, berry, red berry, cranberry, peach, apple, orange, mango, clementine, lemon, lime, tropical fruit, papaya, rhubarb, grape, durian, dragon fruit, cucumber, blueberry, mulberry, citrus fruits, Drambuie, bourbon, scotch, whiskey, gin, tequila, rum, spearmint, peppermint, lavender, aloe vera, cardamom, celery, cascarilla, nutmeg, sandalwood, bergamot, geranium, khat, naswar, betel, shisha, pine, honey essence, rose oil, vanilla, lemon oil, orange oil, orange blossom, cherry blossom, cassia, caraway, cognac, jasmine, ylang-ylang, sage, fennel, wasabi, piment, ginger, coriander, coffee, hemp, a mint oil from any species of the genus Mentha, eucalyptus, star anise, cocoa, lemongrass, rooibos, flax, Ginkgo biloba, hazel, hibiscus, laurel, mate, orange skin, rose, tea such as green tea or black tea, thyme, juniper, elderflower, basil, bay leaves, cumin, oregano, paprika, rosemary, saffron, lemon peel, mint, beefsteak plant, curcuma, cilantro, myrtle, cassis, valerian, pimento, mace, damien, marjoram, olive, lemon balm, lemon basil, chive, carvi, verbena, tarragon, limonene, thymol, camphene), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, liquid such as an oil, solid such as a powder, or gasone or more of extracts (e.g., licorice, hydrangea, Japanese white bark magnolia leaf, chamomile, fenugreek, clove, menthol, Japanese mint, aniseed, cinnamon, herb, wintergreen, cherry, berry, peach, apple, Drambuie, bourbon, scotch, whiskey, spearmint, peppermint, lavender, cardamom, celery, cascarilla, nutmeg, sandalwood, bergamot, geranium, honey essence, rose oil, vanilla, lemon oil, orange oil, cassia, caraway, cognac, jasmine, ylang-ylang, sage, fennel, piment, ginger, anise, coriander, coffee, or a mint oil from any species of the genus Mentha), flavor enhancers, bitterness receptor site blockers, sensorial receptor site activators or stimulators, sugars and/or sugar substitutes (e.g., sucralose, acesulfame potassium, aspartame, saccharine, cyclamates, lactose, sucrose, glucose, fructose, sorbitol, or mannitol), and other additives such as charcoal, chlorophyll, minerals, botanicals, or breath freshening agents. They may be imitation, synthetic or natural ingredients or blends thereof. They may be in any suitable form, for example, oil, liquid, or powder.

In some embodiments, the flavor comprises menthol, spearmint and/or peppermint. In some embodiments, the flavor comprises flavor components of cucumber, blueberry, citrus fruits and/or redberry. In some embodiments, the flavor comprises eugenol. In some embodiments, the flavor comprises flavor components extracted from tobacco. In some embodiments, the flavor may comprise a sensate, which is intended to achieve a somatosensorial sensation which are usually chemically induced and perceived by the stimulation of the fifth cranial nerve (trigeminal nerve), in addition to or in place of aroma or taste nerves, and these may include agents providing heating, cooling, tingling, numbing effect. A suitable heat effect agent may be, but is not limited to, vanillyl ethyl ether and a suitable cooling agent may be, but not limited to eucalyptol, WS-3.

The carrier constituent may comprise one or more constituents capable of forming an aerosol. In some embodiments, the carrier constituent may comprise one or more of glycerine, glycerol, propylene glycol, diethylene glycol, triethylene glycol, tetraethylene glycol, 1,3-butylene glycol, erythritol, meso-Erythritol, ethyl vanillate, ethyl laurate, a diethyl suberate, triethyl citrate, triacetin, a diacetin mixture, benzyl benzoate, benzyl phenyl acetate, tributyrin, lauryl acetate, lauric acid, myristic acid, and propylene carbonate.

The one or more other functional constituents may comprise one or more of pH regulators, coloring agents, preservatives, binders, fillers, stabilizers, and/or antioxidants.

In some embodiments, the article for use with the non-combustible aerosol provision device may comprise aerosolizable material or an area for receiving aerosolizable material. In some embodiments, the article for use with the non-combustible aerosol provision device may comprise a mouthpiece. The area for receiving aerosolizable material may be a storage area for storing aerosolizable material. For example, the storage area may be a reservoir. In some embodiments, the area for receiving aerosolizable material may be separate from, or combined with, an aerosol generating area.

Thus there has been described an aerosol provision system comprising an energy store, wherein the discharge current of the energy store is less than 0.5 C.

The aerosol provision system may be used in a tobacco industry product, for example a non-combustible aerosol provision system.

In one embodiment, the tobacco industry product comprises one or more components of a non-combustible aerosol provision system, such as a heater and an aerosolizable substrate.

In one embodiment, the aerosol provision system is an electronic cigarette also known as a vaping device.

In one embodiment the electronic cigarette comprises a heater, a power supply capable of supplying power to the heater, an aerosolizable substrate such as a liquid or gel, a housing and optionally a mouthpiece.

In one embodiment the aerosolizable substrate is contained in or on a substrate container. In one embodiment the substrate container is combined with or comprises the heater.

In one embodiment, the tobacco industry product is a heating product which releases one or more compounds by heating, but not burning, a substrate material. The substrate material is an aerosolizable material which may be for example tobacco or other non-tobacco products, which may or may not contain nicotine. In one embodiment, the heating device product is a tobacco heating product.

In one embodiment, the heating product is an electronic device.

In one embodiment, the tobacco heating product comprises a heater, a power supply capable of supplying power to the heater, an aerosolizable substrate such as a solid or gel material.

In one embodiment the heating product is a non-electronic article.

In one embodiment the heating product comprises an aerosolizable substrate such as a solid or gel material, and a heat source which is capable of supplying heat energy to the aerosolizable substrate without any electronic means, such as by burning a combustion material, such as charcoal.

In one embodiment the heating product also comprises a filter capable of filtering the aerosol generated by heating the aerosolizable substrate.

In some embodiments the aerosolizable substrate material may comprise an aerosol or aerosol generating agent or a humectant, such as glycerol, propylene glycol, triacetin or diethylene glycol.

In one embodiment, the tobacco industry product is a hybrid system to generate aerosol by heating, but not burning, a combination of substrate materials. The substrate materials may comprise for example solid, liquid or gel which may or may not contain nicotine. In one embodiment, the hybrid system comprises a liquid or gel substrate and a solid substrate. The solid substrate may be for example tobacco or other non-tobacco products, which may or may not contain nicotine. In one embodiment, the hybrid system comprises a liquid or gel substrate and tobacco.

In order to address various issues and advance the art, the entirety of this disclosure shows by way of illustration various embodiments in which the claimed invention(s) may be practiced and provide for a superior electronic aerosol provision system. The advantages and features of the disclosure are of a representative sample of embodiments only, and are not exhaustive and/or exclusive. They are presented only to assist in understanding and teach the claimed features. It is to be understood that advantages, embodiments, examples, functions, features, structures, and/or other aspects of the disclosure are not to be considered limitations on the disclosure as defined by the claims or limitations on equivalents to the claims, and that other embodiments may be utilised and modifications may be made without departing from the scope and/or spirit of the disclosure. Various embodiments may suitably comprise, consist of, or consist essentially of, various combinations of the disclosed elements, components, features, parts, steps, means, etc. In addition, the disclosure includes other inventions not presently claimed, but which may be claimed in future.

1. An aerosol provision system comprising:
an energy store, wherein the discharge current of the energy store is less than 2 C or less than 0.5 C.

2. An aerosol provision system according to claim 1, comprising an aerosol generating mechanism for providing aerosol from an aerosol generating medium, wherein the energy store is arranged to directly deliver energy to the heater for heating.

3. An aerosol provision system according to claim 2, wherein the aerosol generating mechanism is a heater.

4. An aerosol provision system according to claim 3, wherein the heater has a high thermal mass.

5. An aerosol provision system according to claim 3, wherein the heater has a mass of around 5 grams.

6. An aerosol provision system according to claim 3, wherein the aerosol provision system has a power section comprising the energy store and a heater section comprising the heater, wherein the power section and heater section are removably connectable to one another.

7. An aerosol provision system according to claim 3, wherein the energy store provides energy to the heater to reach an operational temperature for a first smoking session, wherein the operational temperature is a temperature sufficient to generate an aerosol from an aerosol generating medium, the heater having a rate of heat transfer so that, in use, at least some energy provided to the heater for the first smoking session is retained to generate an aerosol from an aerosol generating medium in a second smoking session, and wherein the second smoking session is subsequent to the first smoking session.

8. An aerosol provision system according to claim 7, wherein the operational temperature is from around 220° C. to around 260° C.

9. An aerosol provision system according to claim 7, wherein the rate of heat transfer of the heater is from around 15 J/s to around 30 J/s.

10. An aerosol provision system according to any of claim 7, wherein the second smoking session is around 5 seconds to 20 seconds subsequent to the first smoking session.

11. A method of producing an aerosol from an aerosol provision system, the method comprising:
providing energy to a heater to produce an aerosol from an aerosol generating medium,
providing an aerosol from an aerosol generating medium for a first smoking session,
cease providing energy to the heater,
providing an aerosol from an aerosol generating medium for a second smoking session,
wherein the second smoking session occurs at least 30 s after the step of cease providing energy the heater.

12. A method of producing an aerosol according to claim 11, wherein the rate of provision of energy to the heater to produce an aerosol is around 15 to 30 J/s.

13. Aerosol provision means comprising:
an energy store means, wherein the discharge current of the energy store means is less than 2 C or less than 0.5 C.

14. An aerosol provision system including a heater for generating an aerosol from an aerosol precursor, the heater having a thermal capacity TC and the aerosol generation taking a power level PL, wherein the ratio TC/PL exceeds a predetermined threshold PT.

15. An aerosol provision system according to claim 14, further comprising an energy store, wherein the discharge current of the energy store is less than 2 C or less than 0.5 C.

16. An aerosol provision system according to claim 15, wherein the aerosol provision system has a power section comprising the energy store and a heater section comprising the heater, wherein the power section and heater section are removably connectable to one another.

17. An aerosol provision system according to claim 14 wherein the heater has a mass of around 5 grams.

18. An aerosol provision system according to claim 14, wherein the heater has an operational temperature of from around 220° C. to around 260° C.

19. An aerosol provision system according to claim 14 to 18, wherein the heater has a rate of heat transfer from around 15 J/s to around 30 J/s.

20. An aerosol provision system according to claim 15, or an aerosol provision means according to claim 13, wherein the discharge current of the energy store means is less than 0.5 C.

21. An aerosol provision system comprising:
an energy store;
a heater for generating an aerosol from an aerosol generating medium, wherein the heater has a first specific heat capacity x J/(kg·K); and
a control mechanism, wherein the control mechanism is arranged and adapted:
(i) to cause energy to be transferred from the energy store to the heater, wherein the energy transferred to the heater is sufficient for the heater to reach an operational temperature or operational status which is sufficient to produce an aerosol from an aerosol generating medium during the course of one or more smoking sessions;
(ii) to cause an aerosol to be provided from the aerosol generating medium during a first smoking session;
(iii) to cause the energy store to cease transferring energy to the heater; and
(iv) to cause an aerosol to be provided from the aerosol generating medium during a second and optionally further subsequent smoking session(s).

22. An aerosol provision system as claimed in claim 21, wherein x is in the range: (i) 400-500; (ii) 500-600; (iii) 600-700; (iv) 700-800; (v) 800-900; (vi) 900-1000; or (vi) >1000.

23. An aerosol provision system as claimed in claim 21, wherein the discharge current of the energy store is less than 2 C or less than 0.5 C.

24. A method producing an aerosol comprising:
providing an energy store;
providing a heater for generating an aerosol from an aerosol generating medium, wherein the heater has a first specific heat capacity x J/(kg·K);
causing energy to be transferred from the energy store to the heater, wherein the energy transferred to the heater is sufficient for the heater to reach an operational temperature or operational status which is sufficient to produce an aerosol from an aerosol generating medium during the course of one or more smoking sessions;
causing an aerosol to be provided from the aerosol generating medium during a first smoking session;
causing the energy store to cease transferring energy to the heater; and
causing an aerosol to be provided from the aerosol generating medium during a second and optionally further subsequent smoking session(s).
